(19) United States
(12) Patent Application Publication
(10) Pub. No.: US 2018/0254454 A1
(43) Pub. Date: Sep. 6, 2018

(54) NONAQUEOUS ELECTROLYTE SECONDARY BATTERY SEPARATOR

(71) Applicant: Sumitomo Chemical Company, Limited, Tokyo (JP)

(72) Inventor: Chikae YOSHIMARU, Osaka-shi (JP)

(21) Appl. No.: 15/910,222

(22) Filed: Mar. 2, 2018

(30) Foreign Application Priority Data
Mar. 3, 2017 (JP) 2017-041086

(51) Int. Cl. H01M 2/16; H01M 2/14

(52) U.S. Cl. CPC H01M 2/1653; H01M 10/0525; H01M 2/145; H01M 2/1686

(57) ABSTRACT

To provide a nonaqueous electrolyte secondary battery separator that allows a nonaqueous electrolyte secondary battery including the nonaqueous electrolyte secondary battery separator to have a reduced increase in the battery resistance after a charge and discharge cycle, a nonaqueous electrolyte secondary battery separator is arranged such that the number of bends is not less than 1600, the number having been measured (i) with use of a test piece of a polyolefin porous film which test piece has a longitudinal direction in a transverse direction (TD) of the polyolefin porous film and (ii) by an MIT tester method, the bends having been carried out until a longitudinal dimension of the test piece changes by 2.4 cm.

This Nonprovisional application claims priority under 35 U.S.C. § 119 on Patent Application No. 2017-041086 filed in Japan on Mar. 3, 2017, the entire contents of which are hereby incorporated by reference.

### TECHNICAL FIELD

The present invention relates to (i) a separator for a nonaqueous electrolyte secondary battery (hereinafter referred to as a “nonaqueous electrolyte secondary battery separator”), (ii) a laminated separator for a nonaqueous electrolyte secondary battery (hereinafter referred to as a “nonaqueous electrolyte secondary battery laminated separator”), (iii) a member for a nonaqueous electrolyte secondary battery (hereinafter referred to as a “nonaqueous electrolyte secondary battery member”), and (iv) a nonaqueous electrolyte secondary battery.

### BACKGROUND ART

Nonaqueous electrolyte secondary batteries such as a lithium secondary battery are currently in wide use as (i) batteries for devices such as a personal computer, a mobile telephone, and a portable information terminal or (ii) on-vehicle batteries.

A known example of a separator for use in such a nonaqueous electrolyte secondary battery is a porous film containing a polyolefin as a main component as disclosed in Patent Literature 1.

### CITATION LIST

### Patent Literature

[Patent Literature 1]

Japanese Patent Application Publication, Tokukaihei, No. 11-130900 (Publication Date: May 18, 1999)

### SUMMARY OF INVENTION

### Technical Problem

Conventional art has been insufficient in decreasing the rate of increase in resistance after a charge and discharge cycle, and leaves room for improvement.

An aspect of the present invention has been attained in view of the above issue. It is an object of an aspect of the present invention to provide a nonaqueous electrolyte secondary battery separator that allows a nonaqueous electrolyte secondary battery including the nonaqueous electrolyte secondary battery separator to have a reduced increase in the battery resistance after a charge and discharge cycle.

### Solution to Problem

A nonaqueous electrolyte secondary battery separator in accordance with an aspect of the present invention is a nonaqueous electrolyte secondary battery separator, including: a polyolefin porous film, a number of bends being not less than 1600, the number having been measured (i) with use of a test piece of the polyolefin porous film which test piece has a longitudinal direction in a transverse direction (TD) of the polyolefin porous film and (ii) by an MIT tester method defined in JIS P 8115 (1994), the bends having been carried out until a longitudinal dimension of the test piece changes by 2.4 cm.

A nonaqueous electrolyte secondary battery separator in accordance with an aspect of the present invention may preferably be arranged such that an amount of change per bend being not less than 0.0004 mm per bend, the amount having been measured (i) with use of a test piece of the polyolefin porous film which test piece has a longitudinal direction in a machine direction (MD) of the polyolefin porous film and (ii) by the MIT tester method, the change having been made to a longitudinal dimension of the test piece through 5000 bends of the test piece.

A nonaqueous electrolyte secondary battery laminated separator in accordance with an aspect of the present invention includes: a nonaqueous electrolyte secondary battery separator in accordance with an aspect of the present invention; and an insulating porous layer.

A nonaqueous electrolyte secondary battery member in accordance with an aspect of the present invention includes:

a positive electrode; a nonaqueous electrolyte secondary battery separator in accordance with an aspect of the present invention or a nonaqueous electrolyte secondary battery laminated separator in accordance with an aspect of the present invention; and a negative electrode, the positive electrode, the nonaqueous electrolyte secondary battery separator or the nonaqueous electrolyte secondary battery laminated separator, and the negative electrode being arranged in this order.

A nonaqueous electrolyte secondary battery in accordance with an aspect of the present invention includes: a nonaqueous electrolyte secondary battery separator in accordance with an aspect of the present invention or a nonaqueous electrolyte secondary battery laminated separator in accordance with an aspect of the present invention.

### Advantageous Effects of Invention

An aspect of the present invention advantageously reduces an increase in the battery resistance which increase occurs after a charge and discharge cycle.

### BRIEF DESCRIPTION OF DRAWINGS

FIG. 1 is a diagram schematically illustrating an MIT tester.

FIG. 2 is a diagram schematically illustrating a method of, after cooling a heat-fixed stretched film, additionally stretching the stretched film in an Example.

### DESCRIPTION OF EMBODIMENTS

The following description will discuss an embodiment of the present invention. The present invention is, however, not limited to the embodiment below. The present invention is not limited to the arrangements described below, but may be altered in various ways by a skilled person within the scope of the claims. The present invention also encompasses in its technical scope any embodiment based on an appropriate combination of technical means disclosed in different embodiments. Note that numerical expressions in the form of “A to B” herein mean “not less than A and not more than B” unless otherwise stated.

[1. Nonaqueous Electrolyte Secondary Battery Separator]

A nonaqueous electrolyte secondary battery separator in accordance with an embodiment of the present invention is a nonaqueous electrolyte secondary battery separator, including: a polyolefin porous film, a number of bends being not less than 1600, the number having been measured (i) with use of a test piece of the polyolefin porous film which test piece has a longitudinal direction in a transverse direction (TD) of the polyolefin porous film and (ii) by an MIT tester method defined in JIS P 8115 (1994), the bends having been carried out until a longitudinal dimension of the test piece changes by 2.4 cm.

The present specification may use the simple term “porous film” to refer to a polyolefin porous film. Further, the present specification uses (i) the term “machine direction (MD)” about a porous film to refer to a direction in which the porous film is conveyed during the production and (ii) the term “transverse direction (TD)” about a porous film to refer to a direction perpendicular to the MD of the porous film.

<Polyolefin Porous Film>

A nonaqueous electrolyte secondary battery separator in accordance with an embodiment of the present invention includes a polyolefin porous film, and is preferably made of a polyolefin porous film. A porous film has therein many pores connected to one another so that a gas and a liquid can pass through the porous film from one side to the other side. The porous film can be a nonaqueous electrolyte secondary battery separator or a base material of a later-described nonaqueous electrolyte secondary battery laminated separator. In a case where a battery including a nonaqueous electrolyte secondary battery separator including a porous film generates heat, the porous film melts so as to make the nonaqueous electrolyte secondary battery separator non-porous. Thus, the porous film can impart a shutdown function to the nonaqueous electrolyte secondary battery separator.

The term “polyolefin porous film” refers to a porous film containing a polyolefin-based resin as a main component. The phrase “containing a polyolefin-based resin as a main component” means that the porous film contains a polyolefin-based resin at a proportion of not less than 50% by volume, preferably not less than 90% by volume, more preferably not less than 95% by volume, relative to all the materials of the porous film.

Examples of the polyolefin-based resin that the porous film contains as a main component include, but are not particularly limited to, homopolymers and copolymers both of which are thermoplastic resins and are each produced through polymerization of a monomer(s) such as ethylene, propylene, 1-butene, 4-methyl-1-pentene, and/or 1-hexene. Specifically, examples of such homopolymers include polyethylene, polypropylene, and polybutene, and examples of such copolymers include an ethylene-propylene copolymer. The porous film can include a layer containing only one of these polyolefin-based resins or a layer containing two or more of these polyolefin-based resins. Among these, polyethylene is preferable as it is capable of preventing (shutting down) a flow of an excessively large electric current at a lower temperature. A high molecular weight polyethylene containing ethylene as a main component is particularly preferable. Note that the porous film can contain a component(s) other than a polyolefin as long as such a component does not impair the function of the layer.

Examples of the polyethylene encompass low-density polyethylene, high-density polyethylene, linear polyethylene (ethylene-α-olefin copolymer), and ultra-high molecular weight polyethylene. Among these polyethylenes, an ultra-high molecular weight polyethylene is more preferable, and an ultra-high molecular weight polyethylene containing a high molecular weight component having a weight-average molecular weight of 5×10⁵ to 15×10⁶ is even more preferable. In particular, the polyolefin-based resin more preferably contains a high molecular weight component having a weight-average molecular weight of not less than 1,000,000 because such a polyolefin-based resin allows a porous film and a nonaqueous electrolyte secondary battery laminated separator to have a higher strength.

The porous film has a thickness of preferably 4 μm to 40 μm, more preferably 5 μm to 20 μm. It is preferable that the porous film have a thickness of not less than 4 μm because it is possible to sufficiently prevent an internal short circuit of the battery. Meanwhile, it is preferable that the porous film have a thickness of not more than 40 μm because it is possible to prevent a nonaqueous electrolyte secondary battery from being large in size.

The porous film typically has a weight per unit area of preferably 4 g/m² to 20 g/m², more preferably 5 g/m² to 12 g/m², so as to allow a nonaqueous electrolyte secondary battery to have a higher weight energy density and a higher volume energy density.

The porous film has an air permeability of preferably 30 sec/100 mL to 500 sec/100 mL, more preferably 50 sec/100 mL to 300 sec/100 mL, in terms of Gurley values. This allows a nonaqueous electrolyte secondary battery separator to have sufficient ion permeability.

The porous film has a porosity of preferably 20% by volume to 80% by volume, more preferably 30% by volume to 75% by volume. This makes it possible to (i) retain a larger amount of electrolyte and (ii) reliably prevent (shut down) a flow of an excessively large electric current at a lower temperature.

The porous film has pores each having a pore size of preferably not more than 0.3 μm, more preferably not more than 0.14 μm. This allows the nonaqueous electrolyte secondary battery separator to achieve sufficient ion permeability and to prevent particles, constituting an electrode, from entering the nonaqueous electrolyte secondary battery separator.

The porous film has a strength in the TD which strength is within a particular range. The strength can be determined on the basis of the number of bends measured with use of a test piece with a longitudinal direction in the TD of the porous film by the MIT tester method defined in JIS P 8115 (1994). The number of bends until the longitudinal dimension of the test piece changes by 2.4 cm is preferably not less than 1600, more preferably not less than 2000, even more preferably not less than 2500, and is preferably not more than 40000, more preferably not more than 35000, even more preferably not more than 30000.

The number of bends indicates how extendable the porous film is in the TD. The number of bends being not less than 1600 indicates that the porous film is somewhat not easily extendable in the TD. With this arrangement, a separator including the porous film will not likely become wrinkled or have a deformed internal structure, thereby achieving a reduced increase in the battery resistance.

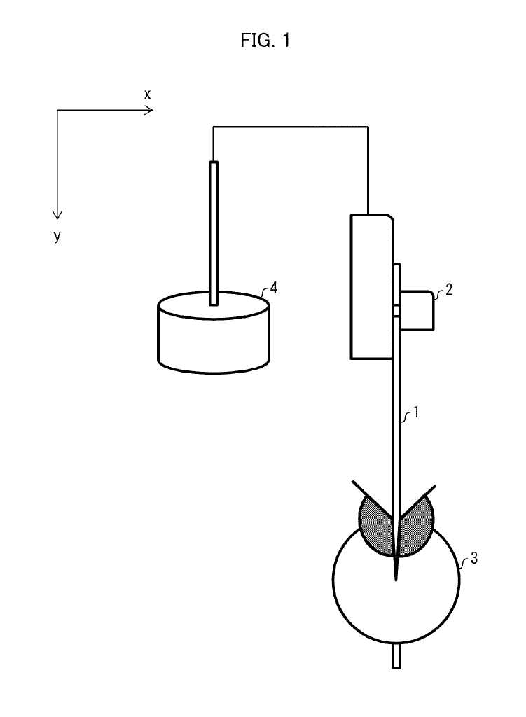

FIG. 1 is a diagram schematically illustrating an MIT tester for use in the MIT tester method. FIG. 1 shows an x axis indicative of the horizontal direction and a y axis indicative of the vertical direction. The following description will outline the MIT tester method. The MIT tester includes a spring-loaded clamp 2 and a bending clamp 3. A longitudinal end of a test piece 1 is clamped by the spring-loaded clamp 2, while the other end is clamped by the bending clamp 3. The test piece 1 is thereby fixed. The spring-loaded clamp 2 is connected with a weight 4. Tension is thus being applied to the test piece 1 in the longitudinal direction. In this state, the longitudinal direction of the test piece 1 is parallel to the vertical direction. The bending clamp 3 is then rotated so that the test piece 1 is bent.

Measurement of the number of bends involves use of a test piece of the porous film which test piece has a longitudinal direction in the TD of the porous film. In other words, the test piece for use in the measurement of the number of bends has been prepared to have a longitudinal direction parallel to the TD of the porous film. Stated further differently, the measurement of the number of bends involves a test piece fixed such that the TD of the porous film is parallel to the vertical direction.

In a case where a test piece of the porous film which test piece has a longitudinal direction in the MD of the porous film has been bent 5000 times, the amount of change per bend in the longitudinal dimension of the test piece is preferably within a particular range as measured by the MIT tester method defined in JIS P 8115 (1994). Specifically, the amount of change is preferably not less than 0.0004 mm per bend, more preferably not less than 0.0005 mm per bend, and is preferably not more than 0.005 mm per bend, more preferably not more than 0.0045 mm per bend.

The amount of change indicates how strong the porous film is in the MD. The amount of change being not less than 0.0004 mm per bend indicates that the porous film is somewhat flexible in the MD. The porous film, in other words, has good followability with respect to deformation. This renders displacement unlikely between the separator and an electrode composite layer. This in turn renders unlikely occurrence of uneven electric current and a gap between an electrode and the separator, thereby achieving a reduced increase in the resistance at the electrode interface.

Measurement of the amount of change involves use of a test piece of the porous film which test piece has a longitudinal direction in the MD of the porous film. In other words, the test piece for use in the measurement of the amount of change has been prepared to have a longitudinal direction parallel to the MD of the porous film. Stated further differently, the measurement of the amount of change involves a test piece fixed such that the MD of the porous film is parallel to the vertical direction.

<Method for Producing Porous Film>

The porous film may be produced by any method, and may be produced by, for example, a method of (i) adding a pore forming agent to a resin such as a polyolefin to shape the resin into a film and then (ii) removing the pore forming agent with use of an appropriate solvent.

A specific example is a method for producing a porous film from a polyolefin-based resin containing an ultrahigh molecular weight polyethylene. In this case, it is preferable in terms of production cost to produce a porous film by the method including the steps of:

(1) kneading 100 parts by weight of an ultrahigh molecular weight polyethylene and 100 parts by weight to 500 parts by weight of a pore forming agent such as calcium carbonate or a plasticizing agent to prepare a polyolefin resin composition;

(2) extruding the polyolefin resin composition from an extruder and shaping the polyolefin resin composition into a sheet while cooling the polyolefin resin composition to prepare a sheet-shaped polyolefin resin composition;

(3) removing the pore forming agent from the sheet prepared in the step (2);

(4) stretching the sheet from which the pore forming agent has been removed in the step (3); and

(5) heat-fixing the sheet, which has been stretched in the step (4), at a heat-fixation temperature of not lower than 100° C. and not higher than 150° C. to produce a porous film,

or

(3′) stretching the sheet prepared in the step (2);

(4′) removing the pore forming agent from the sheet stretched in the step (3′); and

(5′) heat-fixing the sheet, which has undergone the step (4′), at a heat-fixation temperature of not lower than 100° C. and not higher than 150° C. to produce a porous film.

The porous film produced as above is preferably stretched and heat-fixed again (hereinafter such stretching may be referred to as “additional stretching” and such heat-fixing may be referred to as “additional heat-fixing”). As a specific example, after the step (5) or (5′), the film cooled to room temperature may be heated and stretched again and be then heat-fixed. Such stretching can improve the crystallinity and crystal orientation of the porous film, and thereby tends to allow the porous film to withstand deformation in the stretching direction more easily. Heat-fixing the porous film thereafter can alleviate stress caused inside the porous film and maintain the effect of the stretching. It is preferable in terms of the method for producing the porous film that the porous film is additionally stretched in the TD, in which the porous film tends to have a relatively low strength.

The additional heat-fixing involves a retention time period within a range of preferably 15 seconds to 600 seconds, more preferably 30 seconds to 300 seconds, even more preferably 45 seconds to 180 seconds. If the retention time period is shorter than 15 seconds, the internal stress caused by additional stretching will not be alleviated, likely causing a problem with handleability of the film such as a curl. If the retention time period is longer than 600 seconds, the crystalline and crystal orientation improved by additional stretching may be degraded, possibly failing to produce the effect of increasing the strength.

Adding a petroleum resin as an additive in the step (1) also tends to result in a porous film excellent in withstanding deformation. For instance, a polyolefin resin composition may be prepared by (i) mixing an ultrahigh molecular weight polyethylene with a petroleum resin, (ii) adding a plasticizing agent such as liquid paraffin to the mixture, and (iii) kneading the resulting mixture. A petroleum resin differs from a typical plasticizing agent in, for example, phase separation with respect to a polyolefin-based resin, and is presumed to tend to, for example, increase the thickness of a resin portion inside the porous film and facilitate crystallization caused by stretching.

Examples of the petroleum resin include (i) an aliphatic hydrocarbon resin obtained through polymerization of a C5 petroleum fraction such as isoprene, pentene, and pentadiene as a main material, (ii) an aromatic hydrocarbon resin obtained through polymerization of a C9 petroleum fraction such as indene, vinyltoluene, and methyl styrene as a main material, (iii) a copolymer resin of the aliphatic hydrocarbon resin and the aromatic hydrocarbon resin, (iv) an alicyclic saturated hydrocarbon resin obtained through hydrogenation of any of the resins (i) to (iii), and (v) various mixtures of the resins (i) to (iv). In a case where the plasticizing agent is an aliphatic hydrocarbon compound, the petroleum resin is preferably an alicyclic saturated hydrocarbon resin.

[2. Nonaqueous Electrolyte Secondary Battery Laminated Separator]

According to another embodiment of the present invention, it is possible to use, as a separator, a nonaqueous electrolyte secondary battery laminated separator including (i) the nonaqueous electrolyte secondary battery separator and (ii) an insulating porous layer. Since the porous film is as described above, the insulating porous layer is described here. The description below may use the simple term “porous layer” to refer to an insulating porous layer.

<Insulating Porous Layer>

The porous layer is normally a resin layer containing a resin and is preferably a heat-resistant layer or an adhesive layer. The resin of which the porous layer is made is preferably a resin that has a function required for the porous layer, that is insoluble in a battery electrolyte, and that is electrochemically stable when the battery is in normal use.

The porous layer is disposed on one surface or both surfaces of the nonaqueous electrolyte secondary battery separator as necessary. In a case where the porous layer is disposed on one surface of the porous film, the porous layer is disposed preferably on that surface of the porous film which faces the positive electrode of a nonaqueous electrolyte secondary battery to be produced, more preferably on that surface of the porous film which will come into contact with the positive electrode.

Examples of the resin of which the porous layer is made encompass: polyolefins; (meth)acrylate-based resins; fluorine-containing resins; polyamide-based resins; polyimide-based resins; polyester-based resins; rubbers; resins with a melting point or glass transition temperature of not lower than 180° C.; and water-soluble polymers.

Among the above resins, polyolefins, acrylate-based resins, fluorine-containing resins, polyamide-based resins, polyester-based resins, and water-soluble polymers are preferable. As the polyamide-based resins, wholly aromatic polyamides (aramid resins) are preferable. As the polyester-based resins, polyarylates and liquid crystal polyesters are preferable.

The porous layer may contain fine particles. The term “fine particles” herein means organic fine particles or inorganic fine particles generally referred to as a filler. Therefore, in a case where the porous layer contains fine particles, the above resin contained in the porous layer functions as a binder resin for binding (i) fine particles with each other and (ii) fine particles with the porous film. The fine particles are preferably electrically insulating fine particles.

Examples of the organic fine particles contained in the porous layer encompass fine particles made of resin.

Specific examples of the inorganic fine particles contained in the porous layer encompass fillers made of inorganic substances such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. These inorganic fine particles are electrically insulating fine particles. The porous layer may contain only one kind of the fine particles or two or more kinds of the fine particles in combination.

Among the above fine particles, fine particles made of an inorganic substance are suitable. Fine particles made of an inorganic oxide such as silica, calcium oxide, magnesium oxide, titanium oxide, alumina, mica, zeolite, aluminum hydroxide, or boehmite are more preferable. Further, fine particles made of at least one kind selected from the group consisting of silica, magnesium oxide, titanium oxide, aluminum hydroxide, boehmite, and alumina are even more preferable. Fine particles made of alumina are particularly preferable.

The porous layer contains fine particle in an amount of preferably 1% by volume to 99% by volume, more preferably 5% by volume to 95% by volume, with respect to 100% by volume of the porous layer. In a case where the porous layer contains fine particle in an amount within the above range, it is less likely for a void, which is formed when fine particles come into contact with each other, to be blocked by a resin or the like. This makes it possible to achieve sufficient ion permeability and an appropriate weight per unit area of the porous film.

The porous layer may contain a combination of two or more kinds of fine particles which kinds differ from each other in particle and/or specific surface area.

The porous layer has a thickness within a range of preferably 0.5 μm to 15 μm per single porous layer, more preferably 2 μm to 10 μm per single porous layer.

If the porous layer has a thickness of less than 1 μm, it may be impossible to sufficiently prevent an internal short circuit caused by breakage or the like of the battery. In addition, the porous layer may be only capable of retaining a reduced amount of electrolyte. If the combined thickness of porous layers on both surfaces of the nonaqueous electrolyte secondary battery separator is more than 30 μm, the rate characteristic and/or cycle characteristic may be degraded.

The porous layer has a weight per unit area per single porous layer within a range of preferably 1 g/m² to 20 g/m², more preferably 4 g/m² to 10 g/m².

The porous layer contains a porous layer constituent component in a volume per single porous layer within a range of preferably 0.5 cm³ to 20 cm³, more preferably 1 cm³ to 10 cm³, even more preferably 2 cm³ to 7 cm³.

The porous layer has a porosity within a range of preferably 20% by volume to 90% by volume, more preferably 30% by volume to 80% by volume, for sufficient ion permeability. The porous layer has pores each having a pore diameter of preferably not more than 3 μm, more preferably not more than 1 μm, so that the nonaqueous electrolyte secondary battery laminated separator will have sufficient ion permeability.

A nonaqueous electrolyte secondary battery laminated separator in accordance with an embodiment of the present invention has a thickness within a range of preferably 5.5 μm to 45 μm, more preferably 6 μm to 25 μm.

A nonaqueous electrolyte secondary battery laminated separator in accordance with an embodiment of the present invention has an air permeability within a range of preferably 30 sec/100 mL to 1000 sec/100 mL, more preferably 50 sec/100 mL to 800 sec/100 mL, in terms of Gurley values.

<Method for Producing Porous Layer>

The porous layer can be produced by, for example, a method of (i) coating a surface of the above-described porous film with a later-described coating solution and (ii) drying the coating solution to deposit a porous layer.

The coating solution for use in a method for producing a porous layer can be prepared normally by (i) dissolving a resin in a solvent and (ii) dispersing fine particles in the solution. The solvent for dissolving the resin serves also as a disperse medium for dispersing fine particles. Depending on the type of solvent, the resin may be dispersed therein to provide an emulsion.

The solvent can be any solvent that does not adversely affect the porous film, that allows the resin to be dissolved uniformly and stably, and that allows the fine particles to be dispersed uniformly and stably. Specific examples of the solvent encompass water and an organic solvent. It is possible to use (i) only one kind of the above solvents or (ii) two or more kinds of the above solvents in combination.

The coating solution can be prepared by any method, provided that the coating solution satisfies conditions such as a resin solid content (resin concentration) and/or the amount of fine particles, each of which conditions needs to be satisfied to prepare a desired porous layer. Specific examples of the method for preparing the coating solution encompass a mechanical stirring method, an ultrasonic dispersion method, a high-pressure dispersion method, and a media dispersion method. The coating solution can contain an additive(s) such as a dispersing agent, a plasticizing agent, a surface active agent, and a pH adjusting agent as a component(s) other than the resin and the fine particles as long as such an additive(s) does not prevent an object of the present invention from being attained.

The coating solution can be applied to the porous film by any method, that is, a porous layer can be formed by any method on a surface of a polyolefin porous film. The porous layer may, as necessary, be formed on a surface of a porous film that has been subjected to a hydrophilization treatment.

The porous layer can be formed by, for example, (i) a method including the steps of applying the coating solution directly to a surface of the porous film and then removing the solvent (dispersion medium), (ii) a method including the steps of applying the coating solution to an appropriate support, removing the solvent (dispersion medium) to form a porous layer, then pressure-bonding the porous layer to the porous film, and subsequently peeling the support off, or (iii) a method including the steps of applying the coating solution to a surface of an appropriate support, then pressure-bonding the porous film to that surface of the support, then peeling the support off, and subsequently removing the solvent (dispersion medium).

The coating solution can be applied by a conventionally publicly known method. Specific examples of such a method include a gravure coater method, a dip coater method, a bar coater method, and a die coater method.

The solvent is typically removed by a drying method. The solvent contained in the coating solution can be replaced with another solvent before a drying operation.

[3. Nonaqueous Electrolyte Secondary Battery Member]

A nonaqueous electrolyte secondary battery member in accordance with an embodiment of the present invention includes a positive electrode, the nonaqueous electrolyte secondary battery separator described above or the nonaqueous electrolyte secondary battery laminated separator described above, and a negative electrode, the positive electrode, the nonaqueous electrolyte secondary battery separator or the nonaqueous electrolyte secondary battery laminated separator, and the negative electrode being arranged in this order.

<Positive Electrode>

The positive electrode is not limited to any particular one, provided that the positive electrode is one that is typically used as the positive electrode of a nonaqueous electrolyte secondary battery. Examples of the positive electrode encompass a positive electrode sheet having a structure in which an active material layer containing a positive electrode active material and a binder resin is formed on a current collector. The active material layer can further contain an electrically conductive agent and/or a binding agent.

Examples of the positive electrode active material encompass a material capable of being doped and dedoped with lithium ions. Specific examples of such a material include a lithium complex oxide containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, and a fired product of an organic polymer compound. It is possible to use (i) only one kind of the above electrically conductive agents or (ii) two or more kinds of the above electrically conductive agents in combination.

Examples of the binding agent encompass (i) fluorine-based resins such as polyvinylidene fluoride, (ii) acrylic resin, and (iii) styrene butadiene rubber. Note that the binding agent serves also as a thickener.

Examples of the positive electrode current collector encompass electric conductors such as Al, Ni, and stainless steel. Among these, Al is more preferable because Al is easily processed into a thin film and is inexpensive.

Examples of a method for producing the positive electrode sheet encompass: a method in which a positive electrode active material, an electrically conductive agent, and a binding agent are pressure-molded on a positive electrode current collector; and a method in which (i) a positive electrode active agent, an electrically conductive agent, and a binding agent are formed into a paste with the use of a suitable organic solvent, (ii) a positive electrode current collector is coated with the paste, and then (iii) the paste is dried and then pressured so that the paste is firmly fixed to the positive electrode current collector.

<Negative Electrode>

The negative electrode is not limited to any particular one, provided that the negative electrode is one that is typically used as the negative electrode of a nonaqueous electrolyte secondary battery. Examples of the negative electrode encompass a negative electrode sheet having a structure in which an active material layer containing a negative electrode active material and a binder resin is formed on a current collector. The active material layer can further contain an electrically conductive agent.

Examples of the negative electrode active material encompass (i) a material capable of being doped and dedoped with lithium ions, (ii) a lithium metal, and (iii) a lithium alloy. Examples of the material encompass carbonaceous materials. Examples of the carbonaceous materials encompass natural graphite, artificial graphite, cokes, carbon black, and pyrolytic carbons.

Examples of the negative electrode current collector encompass Cu, Ni, and stainless steel. Among these, Cu is more preferable because Cu is not easily alloyed with lithium especially in the case of a lithium ion secondary battery and is easily processed into a thin film.

Examples of a method for producing the negative electrode sheet encompass: a method in which a negative electrode active material is pressure-molded on a negative electrode current collector; and a method in which (i) a negative electrode active material is formed into a paste with the use of a suitable organic solvent, (ii) a negative electrode current collector is coated with the paste, and then (iii) the paste is dried and then pressured so that the paste is firmly fixed to the negative electrode current collector.

The paste preferably contains the electrically conductive agent and the binding agent.

A nonaqueous electrolyte secondary battery member in accordance with an embodiment of the present invention can be produced by, for example, arranging the above positive electrode, the above-described nonaqueous electrolyte secondary battery separator or the above-described nonaqueous electrolyte secondary battery laminated separator, and the above negative electrode in this order.

The nonaqueous electrolyte secondary battery member may be produced by any method, and may be produced by a conventionally publicly known method.

[4. Nonaqueous Electrolyte Secondary Battery]

A nonaqueous electrolyte secondary battery in accordance with an embodiment of the present invention includes the above-described nonaqueous electrolyte secondary battery separator or the above-described nonaqueous electrolyte secondary battery laminated separator.

The nonaqueous electrolyte secondary battery may be produced by any method, and may be produced by a conventionally publicly known method. For instance, a nonaqueous electrolyte secondary battery member is produced by the method described above, and then the nonaqueous electrolyte secondary battery member is inserted into a container that serves as a housing of a nonaqueous electrolyte secondary battery. Subsequently, the container is filled with a nonaqueous electrolyte, and is then hermetically sealed under reduced pressure. This produces a nonaqueous electrolyte secondary battery in accordance with an embodiment of the present invention.

<Nonaqueous Electrolyte>

The nonaqueous electrolyte is not limited to any particular one, provided that the nonaqueous electrolyte is one that is typically used as the nonaqueous electrolyte of a nonaqueous electrolyte secondary battery. Examples of the nonaqueous electrolyte include a nonaqueous electrolyte prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use (i) only one kind of the above lithium salts or (ii) two or more kinds of the above lithium salts in combination.

Examples of the organic solvent contained in the nonaqueous electrolyte encompass carbonates, ethers, esters, nitriles, amides, carbamates, sulfur-containing compounds, and fluorine-containing organic solvents obtained by introducing a fluorine group into any of these organic solvents. It is possible to use (i) only one kind of the above organic solvents or (ii) two or more kinds of the above organic solvents in combination.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss the present invention in greater detail with reference to Examples and Comparative Examples. Note, however, that the present invention is not limited to the Examples and Comparative Examples below.

[Measurement]

The Examples and Comparative Examples below measured the number of bends and the amount of change based on the MIT tester method and the 1-kHz resistance increase rate by the methods described below.

<Measurement of Strength Based on MIT Tester Method>

Test pieces were cut out from a porous film to have a longitudinal direction in the MD or TD of the porous film and to have a length of 105 mm and a width of 15 mm.

Specifically, test pieces were prepared that had a dimension of 105 mm in the MD of the porous film and a dimension of 15 mm in the TD of the porous film, and test pieces were prepared that had a dimension of 105 mm in the TD of the porous film and a dimension of 15 mm in the MD of the porous film. These test pieces were used for the MIT tester method.

The MIT tester method was carried out with use of an MIT-type folding endurance tester (available from Yasuda Seiki Seisakusho, Ltd.) in conformity with JIS P 8115 (1994), that is, with a load of 6 N, a radius of 0.38 mm at the bending portion, and a bending rate of 175 reciprocations per minute. While an end of the test piece was fixed, the test piece was bent in a left-right direction to an angle of 135 degrees.

On the basis of the above MIT tester method, the number of bends was measured which bends were carried out until a test piece having a longitudinal direction in the TD of the porous film was deformed by 2.4 cm in the longitudinal direction. The number of bends described here refers to the number of reciprocating bends which number was displayed on the counter of the MIT-type folding endurance tester. The amount of change (mm per bend) in the longitudinal dimension of a test piece having a longitudinal direction in the MD of the porous film was calculated from the amount of change (mm) in the longitudinal dimension of the test piece when the number of bends reached 5000.

<1-kHz Resistance Increase Rate>

(1) Initial Charge/Discharge Test

Nonaqueous electrolyte secondary batteries were initially charged and discharged each of which included a corresponding one of the nonaqueous electrolyte secondary battery separators produced in the Examples and the Comparative Examples and each of which had not undergone a charge and discharge cycle. Specifically, the nonaqueous electrolyte secondary batteries were each subjected to four cycles of initial charge and discharge. Each of the four cycles was carried out at 25° C., at a voltage ranging from 4.1 V to 2.7 V, and at an electric current value of 0.2 C. Note that the value of an electric current at which a battery rated capacity defined as a one-hour rate discharge capacity was discharged in one hour was assumed to be 1 C. This applies also to the description below.

(2) Initial 1-kHz Alternating-Current Resistance Measurement

After the initial charge/discharge test, a voltage having an amplitude of 10 mV was applied to each nonaqueous electrolyte secondary battery at room temperature (25° C.) with use of an LCR meter available from Hioki E.E. Corporation (product name: chemical impedance meter, type 3532-80) to draw a Nyquist plot. The resistance value of the real part of a measured frequency of 1 kHz was read as the resistance value after the initial charge/discharge test. The description below refers to this resistance value as “initial 1-kHz resistance value”.

(3) Cycle Test

Subsequently, the nonaqueous electrolyte secondary batteries were each subjected to 100 cycles of charge and discharge. Each of the 100 cycles was carried out at 55° C., at a constant charge electric current value of 1 C, and at a constant discharge electric current value of 10 C.

(4) 1-kHz Alternating-Current Resistance Measurement after Cycle Test

The resistance value of the real part of a measured frequency of 1 kHz after 100 cycles was read as in (2). The description below refers to this resistance value as “1-kHz resistance value after the cycle test”.

(5) 1-kHz Resistance Increase Rate after 100 Charge/Discharge Cycles

(1-kHz resistance value after the cycle test/initial 1-kHz resistance value)×100 was calculated as a 1-kHz resistance increase rate (%) after 100 charge and discharge cycles.

[Production of Nonaqueous Electrolyte Secondary Battery Separator]

### Comparative Example 1

A commercially available porous polyethylene film (1) (with a thickness of 16.2 μm and a weight per unit area of 10.0 g/m²) was used as a nonaqueous electrolyte secondary battery separator (5).

### Comparative Example 2

First, 68% by weight of ultra-high molecular weight polyethylene powder (GUR2024, available from Ticona Corporation) and 32% by weight of polyethylene wax (FNP-0115, available from Nippon Seiro Co., Ltd.) having a weight-average molecular weight of 1,000 were prepared. Assuming that the total amount of a mixture of the ultra-high molecular weight polyethylene and the polyethylene wax was 100 parts by weight, 0.4 parts by weight of an antioxidant (Irg1010, available from Ciba Specialty Chemicals Corporation), 0.1 parts by weight of an antioxidant (P168, available from Ciba Specialty Chemicals Corporation), and 1.3 parts by weight of sodium stearate were added to the mixture. Then, calcium carbonate (available from Maruo Calcium Co., Ltd.) having an average particle diameter of 0.1 μm was further added so as to account for 38% by volume of the total volume of the resulting mixture. The resulting mixture was, while remaining in the form of powder, mixed in a Henschel mixer, and was then melt-kneaded with use of a twin screw kneading extruder. This produced a polyolefin resin composition.

The polyolefin resin composition was rolled with use of a pair of rollers each having a surface temperature of 150° C. This produced a sheet of the polyolefin resin composition. This sheet was immersed in an aqueous hydrochloric acid solution (containing 4 mol/L of hydrochloric acid and 0.5% by weight of a nonionic surfactant) for removal of the calcium carbonate. The sheet was subsequently stretched 6.2-fold at 105° C. This produced a film having a thickness of 10.9 μm. The film was then heat-fixed at 126° C. This produced a porous polyethylene film (2) as a nonaqueous electrolyte secondary battery separator (6).

### Comparative Example 3

First, 20% by weight of ultra-high molecular weight polyethylene powder (Hi-zex Million 145M, available from Mitsui Chemicals, Inc.) was prepared. This powder was fed into a twin screw kneading extruder through a quantitative feeder and was melt-kneaded. When the powder was melt-kneaded, 80% by weight of liquid paraffin was added under pressure into the twin screw kneading extruder through a pump, and was melt-kneaded together with the powder. Then, the resulting product was extruded from a T-die through a gear pump. This produced a polyolefin resin composition.

The polyolefin resin composition was cooled with use of a cooling roller and was then stretched 6-fold at 118° C. in the MD and TD simultaneously. The stretched polyolefin resin composition in the form of a sheet was immersed in heptane for removal of the liquid paraffin. The polyolefin resin composition was dried at room temperature, and was then heat-fixed in an oven at 120° C. for 1 minute. This produced a porous polyethylene film (3) having a thickness of 14.2 μm. The porous polyethylene film (3) thus produced was used as a nonaqueous electrolyte secondary battery separator (7).

### Example 1

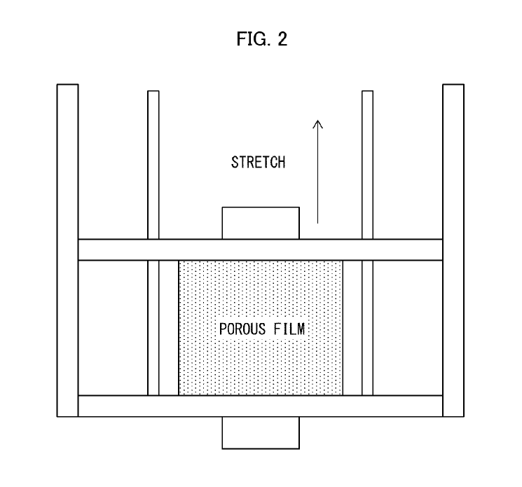

A piece was cut out from the porous polyethylene film (2) produced in Comparative Example 2 which piece was 10.8 cm in the MD and 13 cm in the TD. The cutout was fixed to a stainless-steel jig in the shape of a 15 cm×15 cm frame as illustrated in FIG. 2 in such a manner as to allow the cutout to be additionally stretched in the TD. The cutout was additionally stretched 1.02-fold in length with use of a compact desktop tester (EZ-L, available from Shimadzu Corporation) on which a thermostat bath was placed, with the temperature inside the thermostat bath being 85° C. and the stretching rate being 5 mm per minute. The cutout was then heat-fixed inside the thermostat bath for 1 minute. This produced a porous polyethylene film (4). The porous polyethylene film (4) thus produced was used as a nonaqueous electrolyte secondary battery separator (1).

### Example 2

First, 18% by weight of ultra-high molecular weight polyethylene powder (Hi-zex Million 145M, available from Mitsui Chemicals, Inc.) and 2% by weight of petroleum resin (alicyclic saturated hydrocarbon resin polymerized from indene, vinyltoluene, and methyl styrene as main raw materials and having a softening point of 115° C.) were prepared. Powder of these ingredients was crushed and mixed in a blender until the powder had a uniform particle diameter. Then, the mixed powder thus prepared was fed into a twin screw kneading extruder through a quantitative feeder and was melt-kneaded. When the powder was melt-kneaded, 80% by weight of liquid paraffin was added under pressure into the twin screw kneading extruder through a pump, and was melt-kneaded together with the powder. Then, the resulting product was extruded from a T-die through a gear pump. This produced a polyolefin resin composition.

The polyolefin resin composition was cooled with use of a cooling roller and was then stretched 6.43-fold at 117° C. in the MD. Subsequently, the polyolefin resin composition was stretched 6-fold at 117° C. in the TD.

The stretched polyolefin resin composition in the form of a sheet was immersed in heptane for removal of the liquid paraffin. The polyolefin resin composition was dried at room temperature, and was then heat-fixed in an oven at 120° C. for 1 minute. This produced a porous polyethylene film (5) having a thickness of 19.7 μm. The porous polyethylene film (5) thus produced was used as a nonaqueous electrolyte secondary battery separator (2).

### Example 3

A piece was cut out from the commercially available porous polyethylene film (1) (with a thickness of 16.2 μm and a weight per unit area of 10.0 g/m²), identical to that used in Comparative Example 1, which piece was 10.8 cm in the MD and 13 cm in the TD. The cutout was fixed to a stainless-steel jig in the shape of a 15 cm×15 cm frame as illustrated in FIG. 2 in such a manner as to allow the cutout to be additionally stretched in the TD. The cutout was additionally stretched 1.15-fold in length with use of a compact desktop tester (EZ-L, available from Shimadzu Corporation) on which a thermostat bath was placed, with the temperature inside the thermostat bath being 85° C. and the stretching rate being 5 mm per minute. The cutout was then heat-fixed inside the thermostat bath for 1 minute. This produced a porous polyethylene film (6). The porous polyethylene film (6) thus produced was used as a nonaqueous electrolyte secondary battery separator (3).

### Example 4

A piece was cut out from the commercially available porous polyethylene film (1) (with a thickness of 16.2 μm and a weight per unit area of 10.0 g/m²), identical to that used in Comparative Example 1, which piece was 10.8 cm in the MD and 13 cm in the TD. The cutout was fixed to a stainless-steel jig in the shape of a 15 cm×15 cm frame as illustrated in FIG. 2 in such a manner as to allow the cutout to be additionally stretched in the TD. The cutout was additionally stretched 1.3-fold in length with use of a compact desktop tester (EZ-L, available from Shimadzu Corporation) on which a thermostat bath was placed, with the temperature inside the thermostat bath being 85° C. and the stretching rate being 5 mm per minute. The cutout was then heat-fixed inside the thermostat bath for 1 minute. This produced a porous polyethylene film (7). The film thus produced was used as a nonaqueous electrolyte secondary battery separator (4).

[Preparation of Nonaqueous Electrolyte Secondary Battery]

Next, nonaqueous electrolyte secondary batteries including the respective nonaqueous electrolyte secondary battery separators produced as above in Examples 1 to 4 and Comparative Examples 1 to 3 were prepared as below.

<Positive Electrode>

A commercially available positive electrode was used that had been produced by applying, to an aluminum foil, LiNi_{0.5}Mn_{0.3}Co_{0.2}O₂, an electrically conductive agent, and PVDF at a weight ratio of 92:5:3. The aluminum foil was partially cut off so that a positive electrode active material layer was present in an area of 45 mm×30 mm on the aluminum foil and that a portion of the aluminum foil remained around the area which portion had a width of 13 mm and in which portion the positive electrode active material layer was absent. The positive electrode active material layer had a thickness of 58 μm and a density of 2.50 g/cm³. The positive electrode had a capacity of 174 mAh/g.

<Negative Electrode>

A commercially available negative electrode was used that has been produced by applying, to a copper foil, graphite, styrene-1,3-butadiene copolymer, and sodium carboxymethylcellulose at a weight ratio of 98:1:1. The copper foil was partially cut off so that a negative electrode active material layer was present in an area of 50 mm×35 mm on the copper foil and that a portion of the copper foil remained around the area which portion had a width of 13 mm and in which portion the negative electrode active material layer was absent. The negative electrode active material layer had a thickness of 49 μm and a density of 1.40 g/cm³. The negative electrode had a capacity of 372 mAh/g.

<Assembly>

In a laminate pouch, the positive electrode, the nonaqueous electrolyte secondary battery separator including a porous layer facing the positive electrode, and the negative electrode were disposed on top of each other in this order so as to obtain a nonaqueous electrolyte secondary battery member. During this operation, the positive electrode and the negative electrode were arranged so that the positive electrode active material layer of the positive electrode had a main surface that was entirely covered by the main surface of the negative electrode active material layer of the negative electrode.

Subsequently, the nonaqueous electrolyte secondary battery member was put into a bag made of a laminate of an aluminum layer and a heat seal layer. Further, 0.25 mL of nonaqueous electrolyte was put into the bag. The nonaqueous electrolyte was an electrolyte having a temperature of 25° C. and prepared by dissolving LiPF₆ in a mixed solvent of ethyl methyl carbonate, diethyl carbonate, and ethylene carbonate at a volume ratio of 50:20:30 so that the concentration of LiPF₆ in the electrolyte was 1.0 mole per liter. The bag was then heat-sealed while the pressure inside the bag was reduced. This produced a nonaqueous electrolyte secondary battery. The nonaqueous electrolyte secondary battery had a design capacity of 20.5 mAh.

[Measurement Results]

Table 1 shows the measurement results.

TABLE 1

| | Number of | Amount of | 1-kHz resistance |
|---|---|---|---|
| | bends carried | change per bend | increase rate after |
| | out until 2.4 cm | through 5000 | 100 charge and |
| | change occurs | bends in MD [in | discharge cycles |
| | in TD [in times] | mm per bend] | [%] |
| Example 1 | 2,898 | 0.0005 | 292 |
| Example 2 | 1,709 | 0.0015 | 332 |
| Example 3 | 4,940 | 0.0036 | 331 |
| Example 4 | 23,539 | 0.0044 | 340 |
| Comparative | 1,212 | 0.0025 | 413 |
| Example 1 | | | |
| Comparative | 1,535 | 0.0003 | 529 |
| Example 2 | | | |
| Comparative | 19 | 0.0015 | 421 |
| Example 3 | | | |

In Comparative Examples 1 to 3 (in which in an MIT tester method involving use of a test piece of a porous film which test piece had a longitudinal direction in the TD of the porous film, the number of bends carried out until the longitudinal dimension of the test piece was changed by 2.4 cm was less than 1600), the 1-kHz resistance increase rate after 100 charge and discharge cycles was not less than 400%.

In Comparative Example 2 (in which in an MIT tester method involving use of a test piece of a porous film which test piece had a longitudinal direction in the MD of the porous film, the amount of change per bend in the longitudinal dimension of the test piece after the test piece had been bent 5000 times was less than 0.0004 mm per bend), the 1-kHz resistance increase rate after 100 charge and discharge cycles was not less than 500%. This was even inferior to the respective 1-kHz resistance increase rates after 100 charge and discharge cycles in Comparative Examples 1 and 3.

In Examples 1 to 4 (in which in an MIT tester method involving use of a test piece of a porous film which test piece had a longitudinal direction in the TD of the porous film, the number of bends carried out until the longitudinal dimension of the test piece was changed by 2.4 cm was not less than 1600), the 1-kHz resistance increase rate after 100 charge and discharge cycles was less than 350%. This proves that the respective test pieces of Examples 1 to 4 each had a reduced 1-kHz resistance increase rate after 100 charge and discharge cycles. In Examples 1 to 4, in an MIT tester method involving use of a test piece of a porous film which test piece had a longitudinal direction in the MD of the porous film, the amount of change per bend in the longitudinal dimension of the test piece after the test piece had been bent 5000 times was not less than 0.0004 mm per bend.

### INDUSTRIAL APPLICABILITY

A nonaqueous electrolyte secondary battery separator in accordance with an embodiment of the present invention and a nonaqueous electrolyte secondary battery laminated separator in accordance with an embodiment of the present invention are suitably usable in production of a nonaqueous electrolyte secondary battery having a reduced rate of increase in the battery resistance.

### REFERENCE SIGNS LIST

1 Test piece
2 Spring-loaded clamp
3 Bending clamp
4 Weight

1. A nonaqueous electrolyte secondary battery separator, comprising:
a polyolefin porous film,
a number of bends being not less than 1600, the number having been measured (i) with use of a test piece of the polyolefin porous film which test piece has a longitudinal direction in a transverse direction (TD) of the polyolefin porous film and (ii) by an MIT tester method defined in JIS P 8115 (1994), the bends having been carried out until a longitudinal dimension of the test piece changes by 2.4 cm.

2. The nonaqueous electrolyte secondary battery separator according to claim 1, wherein
an amount of change per bend being not less than 0.0004 mm per bend, the amount having been measured (i) with use of a test piece of the polyolefin porous film which test piece has a longitudinal direction in a machine direction (MD) of the polyolefin porous film and (ii) by the MIT tester method, the change having been made to a longitudinal dimension of the test piece through 5000 bends of the test piece.

3. A nonaqueous electrolyte secondary battery laminated separator, comprising:
a nonaqueous electrolyte secondary battery separator according to claim 1; and
an insulating porous layer.

4. A nonaqueous electrolyte secondary battery member, comprising:
a positive electrode;
a nonaqueous electrolyte secondary battery separator according to claim 1; and
a negative electrode,
the positive electrode, the nonaqueous electrolyte secondary battery separator, and the negative electrode being arranged in this order.

5. A nonaqueous electrolyte secondary battery, comprising:
a nonaqueous electrolyte secondary battery separator according to claim 1.

6. A nonaqueous electrolyte secondary battery member, comprising:
a positive electrode;
a nonaqueous electrolyte secondary battery laminated separator according to claim 3; and
a negative electrode,
the positive electrode, the nonaqueous electrolyte secondary battery laminated separator, and the negative electrode being arranged in this order.

7. A nonaqueous electrolyte secondary battery, comprising:
a nonaqueous electrolyte secondary battery laminated separator according to claim 3.
